(19) United States
(12) Patent Application Publication
(10) Pub. No.: US 2024/0392458 A1
(43) Pub. Date: Nov. 28, 2024

(54) METHOD FOR PRODUCING AN ELECTRODEPOSITED COPPER FOIL FOR LITHIUM SECONDARY BATTERY

(71) Applicant: CIRCUIT FOIL LUXEMBOURG, WILTZ (LU)

(72) Inventors: Guillaume JACQMIN, Bastogne (BE); Pierre ROZEIN, Vielsalm (BE); Michel STREEL, Houffalize (BE)

(21) Appl. No.: 18/695,995

(22) PCT Filed: Dec. 19, 2022
(86) PCT No.: PCT/EP2022/086789

§ 371 Date: Mar. 27, 2024

(30) Foreign Application Priority Data
Dec. 20, 2021 (LU) LU501043

(51) Int. Cl. C25D 1/04; H01M 4/66; H01M 4/75

(52) U.S. Cl. CPC C25D 1/04; H01M 4/661; H01M 4/75

(57) ABSTRACT

The invention relates to an electrodeposited copper foil and its manufacturing method. The copper foil has an as produced tensile strength above 52 kgf/mm2, presents tensile strength above 50 kgf/mm2 after 120 days at 35° C. and presents a recrystallization property under thermal stress. The copper foil is manufactured using an electrolyte comprising: copper at a concentration of at least 60 g/L; sulfuric acid at a concentration of at least 60 g/L; a halogen ion at a concentration of less than 2 mg/L; a thiourea-family electrolytic additive at a concentration between 0.001 mg/L and 0.1 mg/L; and a TOC in the electrolyte of less than 10 mg/L.

### FIELD OF THE INVENTION

The present invention generally relates to the field of electrodeposited copper foils and more specifically to a method of producing an electrodeposited copper foil for application in a lithium secondary battery as well as to the obtained electrodeposited copper foil.

### BACKGROUND OF THE INVENTION

Lithium secondary batteries, as compared to other secondary batteries, have lots of advantages, such as relatively high energy density and high operating voltage, as well as excellent preservation and lifespan characteristics. Accordingly, such lithium secondary batteries are widely used in various portable electronic devices such as personal computers, camcorders, portable telephones, portable CD players, PDA, and electric vehicles.

Electrodeposited copper foils are typically used as negative electrode collector (anode) of the lithium secondary battery. As is known, conventional electrodeposited copper foils are typically smooth on both sides in order to limit the roughness difference between the “matte side” and “shiny side”, which affects the capacity retention rate.

Electrodeposited copper foils for use in lithium secondary batteries are manufactured in a conventional electrolytic cell with rotating cathode drum in front of a non-soluble anode. A typical electrolytic bath comprises a copper sulfuric acid electrolyte generally including the following additives: 3-mercapto-1-propanesulfonic acid sodium salt (MPS) or bis (3-sulfopropyl) disulfide disodium salt (SPS), a nitrogen containing organic leveler, and an organic polymer selected from high molecular weight polysaccharides.

With such manufacturing process, the obtained electrodeposited copper foils typically have a roughness of less than 2.5 μm (Rz ISO) on both sides, a tensile strength of about 320 MPa and an elongation of about 8-10%.

As is known in the art, electrodeposited copper foils may be subject to a phenomenon of room temperature recrystallization, by which the electrodeposited copper foil gradually becomes softer when it is kept at room temperature, until its tensile strength stabilizes after recrystallization (at an average value of about 320 MPa as indicated above). Possible reasons for the recrystallization phenomenon at room temperature are the gradual relaxation of the crystal defects due to the electrolytic deposition and deformation of the crystal lattice due to the adsorption of the additives at the grain boundary.

The mechanical behavior of the electrodeposited copper foil over time is important to users. They wish to be able to buy electrodeposited copper foils that have a stable tensile strength during transport and storage, such that they exhibit the desired (nominal) tensile strength at the time they bring it to their production line for manufacturing battery electrodes. Here the phenomenon of room temperature recrystallization may thus have a negative effect on mechanical properties.

In some applications, battery manufacturers require electrodeposited copper foils designed to exhibit a recrystallization property under thermal stress. Such electrodeposited copper foils exhibit an initial (i.e. as produced) high tensile strength, e.g. above 45 kgf/mm2 and are capable of undergoing recrystallization under a thermal stress due to a manufacturing step e.g. lamination, whereby the tensile strength drops down to below 30 or 25 kgf/mm2 whereas the elongation becomes very high (above 10%).

A commercial electrodeposited copper foil with recrystallization property, noted prior art foil 1, PAF-1, has a thickness between 6 and 10 μm and presents an initial, high tensile strength of about 46 kgf/mm². Due to the design recrystallization property, after a thermal stress of 1 h at 175° C., the tensile strength drops down to 23.5 kgf/mm² and the elongation increases from 3-4% to above 8%.

The PAF-1 foil hence is characterized by a design softening behavior due to recrystallization under a severe thermal stress that is desirable in manufacturing processes. The softening of the foil will typically occur during a lamination process or the like. One shortcoming of this foil is however that it should be used rather rapidly after production, since it is subject to room temperature recrystallization.

By contrast, in other processes, users may wish to employ electrodeposited copper foils that do not exhibit such softening behavior. An example of such commercial foil, noted prior art foil 2, PAF2, with similar thickness ranges and roughness profiles, has a high tensile strength that does not undergo recrystallization at room temperature or upon thermal stress, nor display any stress-relieve properties. For example, PAF-2 foil may be an 8 μm electrodeposited copper foil having an initial tensile strength of about 46.4 kgf/mm² that does not substantially change over time. After a thermal stress of 1 h at 175° C. the tensile strength is still of 45.9 kgf/mm².

As will be appreciated, from the logistics point of view, it is desirable for battery manufacturers to be able to store the electrodeposited copper foils for a certain time period without change of properties. As indicated above, foils with a design recrystallization property under thermal stress, such as e.g. the PAF-1, may see their tensile strength altered after several weeks at room temperature.

### OBJECT OF THE INVENTION

It is an object of the present invention to provide a method for producing an electrodeposited copper foil having, by design, a recrystallization property under thermal stress but that is less prone to room temperature recrystallization.

### SUMMARY OF THE INVENTION

In order to achieve the above-mentioned object, the present invention proposes a method for producing an electrodeposited copper foil, the electrodeposited copper foil being continuously formed in an electroforming cell comprising a rotating drum-shaped cathode, a stationary anode and an electrolyte. According to the invention, the electrolyte comprises or consists of:
copper, preferably in the form of copper ions, at a concentration of at least 60 g/L;
sulfuric acid at a concentration of at least 60 g/L;
a halogen ion at a concentration of less than 2 mg/L; and
a thiourea-family electrolytic additive at a concentration between 0.001 mg/L and 0.1 mg/L;
wherein a TOC content in the electrolyte is less than 10 mg/L.

The invention is based on the findings by the present inventors of a specific bath composition with low amounts of additives, which allows manufacturing an electrodeposited copper foil suitable for lithium secondary battery applications, presenting a recrystallization property under thermal stress, while being more stable than prior art electrodeposited copper foils at room temperature, and hence having an increased shelf life. The present invention relies on the use of an electrolytic bath based on a copper sulfuric acid electrolyte with only few additives in the herein prescribed small amounts.

As defined in claim 1, the electrolyte has a low content of thiourea-family electrolytic additive.

Furthermore, the electrolyte's organic content, conventionally reflected by the TOC, i.e. the total organic carbon, is less than 10 mg/L. The low value of TOC reflects the overall low content of organic additives in the electrolyte.

The present method/electrolytic bath makes it possible to obtain electrodeposited copper foils (also referred to as electrolytic copper foils) exhibiting a stable initial high tensile strength that can be stored for several weeks and even months, as well as a recrystallization property under a thermal stress.

In particular, first tests have confirmed that the present method/electrolyte allows producing an electrodeposited copper foil with the following mechanical properties:
tensile strength as produced: above 52 kgf/mm², in particular in the range 52-65 kgf/mm²;
tensile strength after 120 days storage at 35° C. room temperature: >50 kgf/mm²;
tensile strength after thermal stress of 1 h at 190° C.: 20 to 30 kgf/mm².

Hence, the electrodeposited copper foil obtained with the inventive method is, as produced, a high tensile strength copper foil at more than 52 kgf/mm². The term ‘as produced’ typically indicates the foil as obtained from the production line, in particular without any annealing or thermal treatment. The ‘as produced’ value may typically be measured within hours or several days after production.

The foil is able to recrystallize after a severe thermal stress, as shown by the typical thermal stress 1 h—190° C., whereby the tensile strength becomes low (<30 kgf/mm²) and the elongation very high (>10%).

It will be noted that while recrystallizing at high temperature, the copper foil is fairly stable at room temperature (up to 35° C.) after 120 days, since the tensile strength is still above 50 kgf/mm² or above 52 kgf/mm² for foils having an as produced TS in the upper range.

As used herein, the term ‘recrystallisation property’ designates a capability of a high tensile strength electrodeposited copper foil of undergoing a recrystallization under a predetermined thermal stress (time−temperature), whereby the microstructure changes from columnar to coarse grained, leading to a drop of tensile strength to the lower range and conferring high elasticity to the foil.

In this context, a high tensile strength electrodeposited copper foil preferably has a tensile strength above 50 kgf/mm² and the tensile strength after the thermal stress may be below 30 kgf/mm², with an elongation above 10%.

The test for the recrystallization capability under thermal stress may consist in a thermal stress by heating at 190° C. for 1 h, which typically leads to complete recrystallization of the foil. This is a conventional test used in the Li battery industry. An alternative ‘short’ version thermal stress may involve heating at 250° C. for 2 min. Still alternative ‘short’ thermal stress tests may be carried out at 190° C. for 1 h. The shorter tests are useful for copper foil manufacturers to briefly distinguish between foils presenting a recrystallization property under thermal stress from foils that do not exhibit such property and keep a high TS after thermal shock In general, the thermal stress to obtain a complete recrystallization of the copper foil may be carried out at temperatures in the range of 160 to 210° C. for about 30 to 60 min, or in the range of 230 to 260° C. for several minutes.

‘Tensile strength’ herein conventionally designates the ultimate tensile strength, i.e. the maximum stress that a material can withstand while being stretched/pulled before breaking. It is usually determined by performing a tensile test and recording the stress-strain curve.

As used herein ‘elongation’ designates the elongation at break, as can be determined from a tensile test.

In embodiments, the electrodeposited copper foil has a copper purity of more than 99.8 wt-%, preferably more than 99.9 wt-%. Purity of the electrodeposited copper foil may be measured by electrogravimetry.

The electrolytic additive is a molecule of the thiourea-family present in the bath at a concentration of 0.1 mg/L or less.

In embodiments, the concentration of the thiourea-family electrolytic additive is 0.09 mg/L or less, in particular not more than 0.085, 0.080, 0.075, 0.070, or 0.060, more particularly 0.05 mg/L or less.

The thiourea-family electrolytic additive has a minimum concentration of 0.001 mg/L.

In embodiments, the thiourea-family electrolytic additive may have a minimum concentration of 0.003, 0.005, 0.007, 0.008, or 0.009.

The prescribed concentration of the thiourea-family electrolytic additive is important in the electrolytic bath. It has been found to have an influence on both the recrystallization property and the room temperature stability, and thus allows some control on those parameters. In particular, concentrations of thiourea-family electrolytic additive in the electrolyte above 0.1 mg/L would compromise the desired recrystallization properties upon thermal stress, in particular the recrystallization would be incomplete or not complete enough for the foil to exhibit a tensile strength of 20 to 30 kgf/mm². Conversely, in the case of absence of thiourea-family electrolytic additive, or when using concentrations lower than 0.001 mg/L, the produced copper foil would not be stable upon storage at room temperature, and the shelf life of the foil would not be increased.

In the present text, a thiourea-family electrolytic additive means an organic additive comprising a thiourea-function, i.e. having the following general structure: R₂N—C(═S)—NR₂, with R being hydrogen or any kind of carbon chain, the R groups being identical or different.

In embodiments, the thiourea-family electrolytic additive is selected from N-Methyl-2-thiazolidinethione, 1-(2-Hydroxyethyl)-2-Imidazolidinethione, Tetramethylthiourea, N,N′-Diethylthiourea, N,N′-Dimethylthiourea, N-Allylthiourea, Thiosemicarbazide, 2-Imino-4-thiobiuret, 2-Imidazolidinethione, Acetylthiourea, 1,3-dibutyl-2-thiourea and mixtures thereof.

In embodiments, the TOC in the electrolyte may be less than 7.5 mg/L, preferably less than 4.0 mg/L, more preferably less than 3.0 mg/L or less than 2.5 mg/L. In general, the TOC may be equal to or more than 0.5, 1.0 or 1.5 mg/L.

In embodiments, the halogen ion is a chloride and/or bromide ion.

The halogen ion is present in the electrolyte at a concentration of less than 2 mg/L. The halogen ion is advantageously added up to a prescribed limit to control the tensile strength. Indeed, if the concentration of halogen ion were higher than 2 mg/L in the electrolyte, the tensile strength of the copper foil as produced would be lower and would not satisfy the desired requirements, in particular it would not be above 52 kgf/mm².

In embodiments, the halogen ion may be present in the electrolyte at a concentration of less than 1 mg/L, preferably not more than 0.95, 0.9, 0.85 or 0.8 mg/L, more preferably not more than 0.6 or 0.5 mg/L. Preferably, the minimum concentration of halogen ion in the bath is 0.01, 0.02, 0.03, 0.04 or 0.05 mg/L.

All mentioned concentrations correspond to the concentrations of the respective various components of the electrolyte being provided to the electroforming cell. The electrolyte is continuously supplied with the various components during operation of the electroforming cell to ensure that the concentrations of the various components are always in the prescribed respective ranges. The bath may include conventional unavoidable impurities and traces.

The obtained electrodeposited copper foils may be subjected to further subsequent treatment steps, as desirable for the application. For example, a chromate coating may be applied on both sides of the electrodeposited copper foil.

Furthermore, first tests have shown that the electrodeposited copper foils produced according to the invention have a low profile roughness on both sides appropriate for use in electrodes for lithium secondary batteries. In particular both the matte side (electrolyte side) and the shiny side (drum side) have a Rz ISO of less than 2.5 μm.

The electrodeposited copper foil is formed by applying a current density between the cathode and the anode, which may be comprised between 40 and 80 A/dm², preferably between 40 and 60 A/dm², more preferably between 45 and 55 A/dm².

The electrolyte preferably is maintained at a temperature between 35 and 50° C.

Advantageously, the method is a continuous process and the electrolyte has an endless life time, given continuous supply of copper to be dissolved and additives.

In practice, the concentration of the thiourea-family electrolytic additive in the electrolytic bath may be measured by High pressure liquid chromatography (HPLC). The concentration of the halogen may be measured by ionic chromatography (IC).

According to another aspect, the invention concerns an electrolyte for the production of an electrodeposited copper foil as recited in claim 20.

What was said regarding advantages and embodiments of the inventive method applies mutatis mutandis to the inventive electrolyte.

In yet another aspect, the invention also concerns an electrodeposited copper foil as claimed in claims 10 to 17.

As indicated above, the present electrodeposited copper foil exhibits suitable mechanical properties for industrial use, in particular in the manufacture of electrodes of lithium secondary battery. More specifically, the inventive electrodeposited copper foils have a high tensile strength that is stable over several weeks/months and also presents a recrystallization property under thermal stress.

According to another aspect, the invention relates to an electrode for secondary batteries including the above-described copper foil as a current collector, as claimed in claim 18.

In a lithium secondary battery, for example, a foil including aluminum (Al) is generally used as a cathode (e.g., positive electrode) current collector combined with a cathode active material, and the present electrodeposited copper foil (i.e. as obtained by the present process) is used as anode (e.g., negative electrode) current collector combined with anode active material.

The anode active material layer may include an anode active material, and may further include a conventional binder and/or a conductive material known in the art.

The anode active material is not particularly limited as long as it is a compound capable of intercalation and deintercalation of ions. Non-limiting examples of applicable anode active materials may include, but may not be limited to, carbon-based and silicon-based anode active materials, and in addition, lithium metal or alloys thereof, and other metal oxides such as TiO₂, SnO₂ and Li₄Ti₅O₁: capable of occluding and releasing lithium and having an electric potential of less than 2 V with respect to lithium may be used.

Since a method of manufacturing an electrode for secondary batteries using the above-described copper foil is known to those skilled in the art to which the present invention pertains, a detailed description thereof will be omitted.

According to still another aspect, the invention relates to a secondary battery as claimed in claim 19.

The secondary battery may be a lithium secondary battery, and specifically, may include a lithium metal secondary battery, a lithium ion secondary battery, a lithium polymer secondary battery, a lithium ion polymer secondary battery, or the like. The secondary battery may include liquid or solid electrolytes, e.g. polymer, oxides or sulfides-family.

In an example, the lithium secondary battery may include a cathode (e.g., positive electrode) including a cathode active material; an anode (negative electrode) including an anode active material; and an electrolyte interposed between the cathode and the anode. In addition, a separator may further be included.

The lithium secondary battery may be manufactured according to conventional methods known in the art, for example, by interposing a separator between the cathode and the anode and then introducing the electrolyte to which the electrolyte additive is added.

The electrolyte may include conventional lithium salts known in the art; and an electrolyte solvent.

As the separator, a porous separator, for example, a polypropylene-based, polyethylene-based, or polyolefin-based porous separator may be used, or an organic/inorganic composite separator including an inorganic material may be used.

In the present text, “TOC amount”, “TOC content” and “TOC” are respectively used as synonyms and have the same meaning, which conventionally refers to the total amount of organic carbon present in the electrolyte (i.e. the total content of organic carbon in the electrolyte).

In the present text, any given numeric value covers a range of values form −10% to +10% of said numeric value, preferably a range of values form −5% to +5% of said numeric value, more preferably a range of values form −1% to +1% of said numeric value.

Further details and advantages of the present invention will be apparent from the following detailed description of several not limiting embodiments with reference to the attached drawings.

### BRIEF DESCRIPTION OF THE DRAWINGS

The present invention will now be described, by way of example, with reference to the accompanying drawings, in which:

FIG. 1: is a schematic view of an electroforming cell;

FIG. 2: is a plot of tensile strength vs. temperature, also showing SEM (Scanning Electron Microscope) views copper foils before and after thermal treatment as well as corresponding sketches of the microstructure;

FIG. 3: is a graph illustrating the evolution of tensile strength (TS) for 10 min thermal stresses at various temperatures;

FIG. 4: is a graph showing the evolution of TS over time when copper foils are stored at 35° C.

### DETAILED DESCRIPTION OF PREFERRED EMBODIMENTS

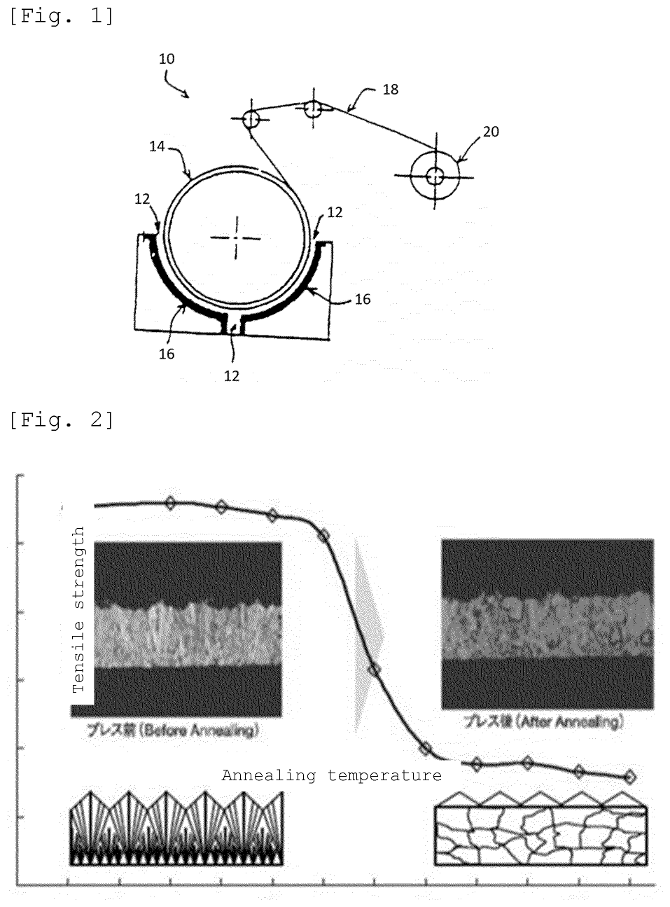

The operative principle of an electroforming cell will first be described with reference to FIG. 1, which is a schematic view of an electroforming cell.

As explained above, the present invention provides a method for producing an electrodeposited copper foil, the electrodeposited copper foil being continuously formed in an electroforming cell, as well as an electrolyte for the production of an electrodeposited copper foil, the produced copper foil having a very low surface roughness and being free of defects.

An electrodeposited copper foil is produced by using an electroforming cell 10 (referred as plating machine in the industry) as shown in FIG. 1 to produce a copper foil 18. In the electroforming cell 10, an electrolyte 12 is passed through an apparatus comprising a drum-shaped cathode 14 (the surface of which is made of stainless steel or titanium) which is rotating and a stationary anode 16 (a lead or a titanium electrode covered by a precious metal oxide) which is provided opposite the cathode 14. An electric current is passed through both electrodes 14, 16 to deposit copper on the surface of the cathode 14 with a desired thickness, thus forming an electrodeposited copper foil 18. The electrodeposited copper foil 18 is then peeled off from the surface of the cathode 14 and coiled onto a storage reel 20. The foil thus prepared is generally referred to as untreated copper foil.

In a subsequent step, for use in the Li battery industry, the electrodeposited copper foil 18 may be subjected to a chromate coating step (not shown)—typically on both sides, and/or any other appropriate treatment step, on one or both sides of the foil.

Electrodeposited copper foils manufactured in accordance with the present invention have an as produced, high tensile strength and are characterized by recrystallization property under thermal stress, by design. That is, the foil is designed, by way of its production method, to exhibit a transition of tensile strength upon application of a severe thermal stress. Namely, the foil, as produced, initially has a rather high tensile strength, typically above or 50-52 kgf/mm², in particular between 50 and 65 kgf/mm². After the thermal stress, the tensile strength drops down to a range between 20 to 45 kgf/mm², depending on the initial tensile strength and conditions of the thermal stress. The elongation then also increases to above 10% up to 20-25%. This recrystallization property, due to a change of microstructure in the electrodeposited copper foil during heating, is illustrated in FIG. 2 (Tensile strength vs. temperature of heat treatment (duration=30 min)). As illustrated by the plot, the TS drops significantly when the treatment temperature increases. The electrodeposited copper foil, out of the electroforming cell, exhibits a columnar grain structure, illustrated on the left of FIG. 2. The heat applied during the thermal stress causes a kind of annealing of the copper foil, during which the crystals rearrange and form rather coarse grains, shown on the right of FIG. 2. This coarse grain structure results in a lower tensile strength.

An initial, high tensile strength is desirable manipulation purposes and allows operating at lower foil thicknesses and higher active material load.

On the other hand, a softer behavior is preferred in consideration of the use of the copper fil integrated in the electrode of the LIB batteries. During manufacture of the battery, the copper foil will be subjected to thermal stresses. During this process, it is desirable that the copper foil recrystallizes in order to obtain a high elongation copper foil, capable of better accommodating anode swelling upon charge and discharge of the battery (especially for high Si content—or other high swelling materials—anodes).

Therefore, the electrodeposited copper foil manufactured according to the inventive process have a design recrystallization property.

However, as will be evidenced by the following examples, the electrodeposited copper foil manufactured according to the inventive process can be stored at room temperature up to 35° C., and up to 120 days without any substantial alteration of their tensile strength.

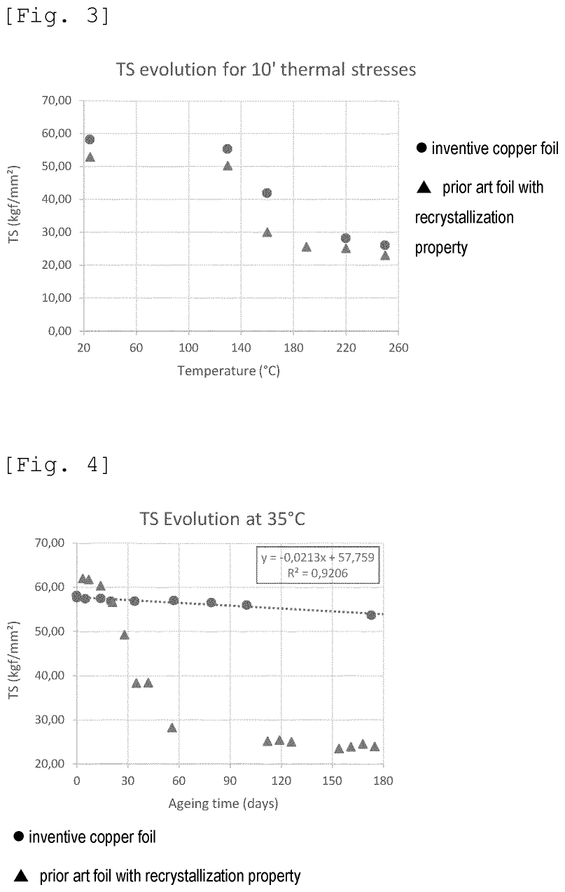

The properties of the inventive foil (manufactured in accordance with the present process) will be also understood from FIGS. 3 and 4, which compare the inventive copper foil (circle) to the prior art foil PAF-1 mentioned in the background art section (triangle).

The plot of FIG. 3 shows the same behavior as in FIG. 2, for a thermal stress of 10 min at temperatures ranging from 20 to 250° C. As can be seen, the inventive foil has an initially high tensile strength, which decreases significantly with thermal stresses above 160° C. The recrystallization property of the inventive foil is comparable to a conventional recrystallizing foil such as PAF-1.

However, as evidenced by FIG. 4, the inventive copper foil has a fairly stable tensile strength at room temperature compared to the conventional recrystallizing foil such as PAF-1. In particular the TS is still above 50 kgf/mm² after 120 days at 35° C.

### EXAMPLES

Electrodeposited copper foils were produced using either a method according to the invention (examples 1 to 3) or a comparative method (comparative examples 1 to 4) not forming part of the invention.

Electrolyte compositions for the various examples are presented in Table 1 below, where MPS stands for 3-mercapto-1-propane sulfonate and HEC stands for hydroxyethyl cellulose.

The concentrations shown in Table 1 correspond to the concentrations of the various compounds of the electrolyte being provided to the electroforming cell. Before starting the electroforming cell (or plating machine), each electrolyte is prepared by solubilizing, in a suitable amount of water, the compounds shown in Table 1. Each electrolyte also includes copper, which is dissolved in the electrolyte with sulfuric acid by oxidizing metallic copper. The copper concentration is 80 g/L. During operation of the electroforming cell, each component is continuously supplied with the various components to ensure that the concentrations of the various components are always in the prescribed respective ranges.

TABLE 1

| | | | | | Thiourea | | |
|---|---|---|---|---|---|---|---|
| | | | | | family | Electrolyte | |
| | MPS | HEC | Gelatin | Cl⁻ | Additive | Temp. | TOC |
| | (mg/L) | (mg/L) | (mg/L) | (mg/L) | (mg/L) | (° C.) | (mg/L) |
| Ex. 1 | — | — | — | 2 | 0.08 | 43 | 2.1 |
| Ex. 2 | — | — | — | 1 | 0.08 | 47 | 2.4 |
| Ex. 3 | — | — | — | 0.5 | 0.05 | 47 | 2.0 |
| Comp. Ex. 1 | 2 | 10 | 20 | 40 | — | 58 | 173 |
| Comp. Ex. 2 | — | — | — | 1 | — | 43 | 2.3 |
| Comp. Ex. 3 | — | — | — | 1 | 5 | 47 | 4.4 |
| Comp. Ex. 4 | — | — | — | 1 | 0.5 | 47 | 3.9 |

It may be noted that TOC is a measure of the total organic carbon of the electrolyte solution which reflects the total organic content of the electrolyte solution. This is not an additive but a measure of organic content known in the art. The rather low TOC content reflects the fact that the electrolyte is low on additives.

The obtained (i.e. as produced) electrodeposited copper foils were then analyzed to determine their mechanical properties such as tensile strength and elongation. The obtained measurement values are noted in Table 2 under ‘as produced’.

It may be noted that the obtained electrodeposited copper foils of example 1 to 3 all have a thickness of 8 μm and present a roughness Rz ISO of less than 2.5 μm on both sides. Part of these foils were subjected to a thermal stress of 1 h at 190° C. and resulting values of tensile strength and elongation are indicated in columns 4-5 of Table 2. Another part of these foils was stored at 35° C. for 120 days and subsequently measured values of tensile strength and elongation are indicated in columns 6-7 of Table 2.

TABLE 2

| | | | After 1 h | | After 120 days | |
|---|---|---|---|---|---|---|
| | As produced | | @190° C. | | @35° C. | |
| | TS | | TS | | TS | |
| | (kgf/ | El | (kgf/ | El | (kgf/ | El |
| | mm²) | (%) | mm²) | (%) | mm²) | (%) |
| Example 1 | 58.1 | 5.6 | 28.2 | 15.4 | 55.2 | 4.6 |
| Example 2 | 54.2 | 5.9 | 27.8 | 14.2 | 52.3 | 4.8 |
| Example 3 | 55.1 | 5.3 | 27.5 | 14.9 | 52.1 | 5.2 |
| Comp. Ex. 1 | 32.2 | 10.2 | 32.0 | 11.1 | 32.1 | 10.9 |
| Comp. Ex. 2 | 59.5 | 4.7 | 25.9 | 13.8 | 25.0 | 7.7 |
| Comp. Ex. 3 | 56.7 | 3.9 | 53.5 | 3.6 | 55.2 | 3.3 |
| Comp. Ex. 4 | 56.7 | 6.0 | 50.0 | 7.9 | 55.2 | 4.9 |

The measurements in table 2 were performed at room temperature, i.e. after cooling for the samples subjected to thermal stress.

As can be seen, the electrodeposited copper foil of example 1-3 have a high initial tensile strength above 50 kgf/mm², present a recrystallization behavior after a severe thermal stress (here 1 h at 190° C.) but can be stored for about 3 months without significant decrease of tensile strength.

By contrast, the foil of comparative example 1—manufactured from an electrolyte with MPS, HEC and gelatin as additives—has a low and stable tensile strength, without recrystallization property under the prescribed thermal stress.

The use of a copper sulfate electrolyte with chloride as sole additive, as shown by comparative example 2, leads to a foil having an initially high tensile strength, with recrystallization property after thermal stress. However, this foil is substantially affected by room temperature recrystallization, since the tensile strength is less than half of the as produced foil after 120 days.

Comparative examples 3 and 4 show that the addition of the thiourea-family additive (in the range of 0.5 to 5 mg/L) to the electrolyte of example 2 stabilizes the (high) tensile strength at room temperature, but the foils do not present the desired recrystallization property under thermal stress. As a result, only electrolyte compositions corresponding to the present invention, i.e. comprising a halogen ion and a thiourea-family electrolytic additive within the prescribed concentrations, allow the manufacture of electrodeposited copper foils having a high tensile strength that is stable over several weeks/months and present a recrystallization property under thermal stress.

### Determining the Tensile Strength and Elongation

Tensile strength measurements were made in accordance with standard: IPC-TM-650 Number 2.4.18.

Tensile strength, more precisely ultimate tensile strength, was measured using a universal testing machine Instron 5564 SP 2962 (UTM) with a gage length of 2.0 inches (50.8 mm). The crosshead speed was set to 2.0 inches/min. The samples were cut into strips having a width of 0.5 inch and a length of 6 inches.

### Determining the Surface Roughness of the Matte Side

The roughness of copper foils was measured with a contact profilometer consisting of a diamond needle (stylus) sliding on the surface. From this measurement a 2D profile of the surface is created, and Rz is calculated as the average distance between the highest peak and lowest valley over 8 sampling lengths. Here the surface roughness Rz refers to ISO (4287:1997).

### Determining the TOC Content of the Electrolyte Solution

TOC (total organic carbon) analysis is carried out with a total carbon analyser. Any appropriate TOC analyser/method may be used.

As is known in the art, TOC analyser determines the amount of carbon in a water sample. Since currently commercial TOC analysers actually measure total carbon, TOC analysis always requires some accounting for the inorganic carbon that is always present. One analysis technique involves a two-stage process commonly referred to as TC-IC. It measures the amount of inorganic carbon (IC) evolved from an acidified aliquot of a sample and also the amount of total carbon (TC) present in the sample. TOC is calculated by subtraction of the IC value from the TC of the sample. Another variant employs oxidation of the sample to evolve carbon dioxide and measuring it as inorganic carbon (IC), then oxidizing and measuring the remaining non-purgeable organic carbon (NPOC). This is called TIC-NPOC analysis. A more common method directly measures TOC in the sample by again acidifying the sample to a pH value of two or less to release the IC gas but in this case to the air not for measurement. The remaining non-purgeable CO₂ gas contained in the liquid aliquot is then oxidized releasing the gases. These gases are then sent to the detector for measurement.

Whether the analysis of TOC is by TC-IC or NPOC methods, it may be broken into three main stages:
1. Acidification
2. Oxidation
3. Detection and Quantification

The first stage is acidification of the sample for the removal of the IC and purgeable organic carbon gases. Addition of acid and inert-gas purging allows all bicarbonate and carbonate ions to be converted to carbon dioxide, and this IC product is vented along with any purgeable organic carbon (POC) that was present. The release of these gases to the detector for measurement or to the air is dependent upon which type of analysis is of interest, the former for TC-IC and the latter for TOC (non-purgeable organic carbon).

The second stage is the oxidation of the carbon in the remaining sample in the form of carbon dioxide (CO₂) and other gases. Modern TOC analysers perform this oxidation step either by high temperature combustion (sometimes using a Pt catalyst), high temperature catalytic oxidation, photo-oxidation, thermo-chemical oxidation (mainly using a heated persulfate source), photo-chemical oxidation (mainly using ultraviolet light and a persulfate source) or electrolytic oxidation.

The third stage is the detection and quantification of the formed CO₂. Conductivity, ultraviolet spectrophotometry and non-dispersive infrared (NDIR) are the three most common detection methods used in commercial TOC analysers.

### Present Method for TOC Measurement

One detailed but non-limiting method for analyzing an electrolytic bath in order to determine its TOC content is disclosed below. This method has been used to determine the TOC of the examples and counter-examples of table 1.

According to this method, TOC (total organic carbon) analysis is carried out with a wet chemical TOC analyser, which works both with an oxidizing agent (peroxydisulfate) and a highly effective UV radiation source for sample oxidation. The performed TOC measurement method is a TIC-NPOC analysis.

The sample (of the electrolytic bath) is diluted (preferably 5 times) with ultrapure water (to avoid detector saturation due to complex matrix effects) and acidified with 10% w/w of phosphoric acid to present a pH below 2 in order to remove the inorganic carbon (dissolved CO₂ from the atmosphere) from the sample. Indeed, in an acidic medium, carbonic acid is present in its protonated form—rather than in its bicarbonate form—, allowing almost complete removal of CO₂ from the solution thanks to the equilibrium between CO₂ and carbonic acid, through a dehydration reaction. The obtained CO: can be vented from the sample to the waste by vector gas (see later).

The organic molecules contained in the sample are then completely oxidized (to CO₂ gas) by a powerful oxidizing chemical (peroxydisulfate), in combination with a highly effective UV radiation source.

A vector gas (nitrogen) is then injected into the sample, carrying this carbon dioxide out of the sample, to the detector. The CO₂ molecules are then detected from the mix they form with the carrier gas, using an Infrared detector (Focus radiation NDIR Detector).

The TOC analyser used to determine the TOC of the examples and counter-examples of table 1 is a commercial apparatus model “MULTI N/C UV HS BU” manufactured by Analytik Jena. Acidification, as well as all the later steps are performed automatically inside of the machine (only the dilution stage is done manually/externally).

1. A method for producing an electrodeposited copper foil, the electrodeposited copper foil being continuously formed in an electroforming cell comprising a rotating drum-shaped cathode, a stationary anode and an electrolyte, wherein the electrolyte comprises:
copper at a concentration of at least 60 g/L;
sulfuric acid at a concentration of at least 60 g/L;
a halogen ion at a concentration of less than 2 mg/L; and
a thiourea-family electrolytic additive at a concentration between 0.001 mg/L and 0.1 mg/L;
wherein a TOC content in the electrolyte is less than 10 mg/L.

2. The method according to claim 1, wherein the halogen ion is present in the electrolyte at a concentration of less than 1 mg/L.

3. The method according to claim 1, wherein the halogen ion is a chloride and/or bromide ion.

4. The method according to claim 1, wherein the thiourea-family electrolytic additive is present in the electrolyte at a concentration of 0.09 mg/L or less.

5. The method according to claim 1, wherein the thiourea-family electrolytic additive is selected from N-Methyl-2-thiazolidinethione, 1-(2-Hydroxyethyl)-2-Imidazolidinethione, Tetramethylthiourea, N,N′-Diethylthiourea, N,N′-Dimethylthiourea, N-Allylthiourea, Thiosemicarbazide, 2-Imino-4-thiobiuret, 2-Imidazolidinethione, Acetylthiourea, 1,3-dibutyl-2-thiourea and mixtures thereof.

6. The method according to claim 1, wherein the TOC in the electrolyte is less 2.5 mg/L.

7. (canceled)

8. The method according to claim 1, wherein copper, respectively sulfuric acid, is present in the electrolyte at a concentration comprised between 60 and 100 g/L.

9. The method according to claim 1, wherein the electrodeposited copper foil is formed by applying a current density between the cathode and the anode, the current density being comprised between 40 and 80 A/dm².

10. The method according to claim 1, wherein an electrolyte temperature is maintained between 35 and 50 C.

11. An electrodeposited copper foil, wherein the electrodeposited copper foil has an as produced tensile strength above 52 kgf/mm², presents tensile strength above 50 kgf/mm² after 120 days at 35° C., and presents a recrystallization property under thermal stress.

12. The electrodeposited copper foil according to claim 11, wherein the electrodeposited copper foil has an as produced tensile strength in the range of 52 to 65 kgf/mm².

13. The electrodeposited copper foil according to claim 11, wherein the electrodeposited copper foil has a tensile strength of about 35 to 45 kgf/mm² after a thermal stress of 10 min at 160° C.

14. The electrodeposited copper foil according to claim 11, wherein the electrodeposited copper foil has a tensile strength of about 20 to 30 kgf/mm² after a thermal stress of 1 h at 190° C.

15. The electrodeposited copper foil according to claim 11, wherein the electrodeposited copper foil has an elongation in the range of 10 to 25% after a thermal stress of 1 h at 190° C.

16. The electrodeposited copper foil according to claim 11, wherein the electrodeposited copper foil has a surface roughness Rz ISO of 2.5 μm or less.

17. The electrodeposited copper foil according to claim 11, wherein the electrodeposited copper foil has a thickness of between 4 and 12 μm.

18. The electrodeposited copper foil according to claim 11, wherein the electrodeposited copper foils has a copper purity of more than 99.8 wt-%.

19. A secondary battery including an electrode comprising:
the electrodeposited copper foil as claimed in claim 10, and an active material layer disposed on the copper foil.

20.-26. (canceled)
